(19) United States
(12) Patent Application Publication
(10) Pub. No.: US 2010/0177698 A1
(43) Pub. Date: Jul. 15, 2010

(54) Network Based Local Mobility Management

(76) Inventors: Patrik Salmela, Kirkkonummi (FI); Kristian Slavov, Espoo (FI); Pekka Nikander, Jorvas (FI)

Correspondence Address: ERICSSON INC., 6300 LEGACY DRIVE, M/S EVR 1-C-11, PLANO, TX, 75024, US

(21) Appl. No.: 12/664,608

(22) PCT Filed: Jun. 14, 2007
(86) PCT No.: PCT/EP2007/055928

§ 371 Date: Mar. 25, 2010

(51) Int. Cl. H04W 8/02

(52) U.S. Cl. 370/328

(57) ABSTRACT

A network comprises a NetLMM domain having at least one Host Identity Protocol proxy coupled to one or more Access Points for communicating with a Mobile Node and acting, in use, as an Access Router for the NetLMM domain. Use of an HIP proxy as an Access Router allows the Access Router itself to be mobile. Furthermore, the Access Router can reside in IPv4 networks, and can even be behind NAT boxes located between the Access Router and a Local Mobility Anchor to which the Access Router is registered. The invention may be applied using a hierarchical architecture in which each domain comprises a respective Local Mobility Anchor coupled to each HIP proxy acting as an Access Router in the domain. The Local Mobility Anchor of a domain may itself be an HIP Local Mobility Anchor. Alternatively, the HIP proxies in a domain may be arranged in a distributed manner.

### FIELD

The present invention relates to a network architecture for providing Network-Based Local Mobility Management (NetLMM), and in particular to a network architecture using Host Identity Protocol (HIP) proxies as Access Routers.

### BACKGROUND

FIG. 1 is a schematic illustration of a network 1 that allows wireless communication with a mobile device 5. The mobile device may be, for example, a mobile telephone or a mobile wireless device such as a BlackBerry™ device and will be referred to generally as a “mobile node” (MN).

As is well known, a mobile node 5 may connect to the network 1 via of a plurality of access points 4 (“AP”). Each access point has a defined area of geographic coverage and, as the mobile node 5 moves, it is “handed-off” from one access point to another when it passes from a geographic area served by one access point to the geographic area served by another access point. It is desirable that the user of the mobile node does not experience any breakdown or interruption in communication when the mobile node is handed-off from one access point to another.

Network-based Local Mobility Management (NetLMM) is an IETF endorsed approach to provide mobile nodes with an illusion of an extended layer 2 link. One specific solution to the NetLMM problem is currently being standardised in the NETLMM working group at the IETF (see http://www.ietf.org/html.charters/NetLMM-charter.html). The basic architecture, as being worked on at the IETF, is described by H. Levkowetz, Editor, et al, “The NetLMM Protocol”, Internet draft draft-giaretta-NetLMM-dt-protocol-02, work in progress, October 2006. FIG. 1 shows the basic NetLMM architecture as defined in H. Levkowetz, Editor, et al., in “The NetLMM Protocol”, Internet draft draft-giaretta-NetLMM-dt-protocol-02, work in progress, October 2006.

In the network of FIG. 1 a number of Access Routers (ARs) 3a,3b,3c, also called Mobility Access Gateways (MAG), participate in a NetLMM domain. The Access Routers of an NetLMM domain are associated with a Local Mobility Anchor (LMA) 2a,2b; in the example of FIG. 1 the Access Routers 3a,3b participate in one NetLMM domain associated with one Local Mobility Anchor 2a, whereas the Access Router 3c participates in a different NetLMM domain associated with another Local Mobility Anchor 2b. The Access Routers in one NetLMM domain all announce the same IPv6 routing prefix in their Neighbour Discovery Protocol (NDP) Router Advertisement (RA) messages. This creates the illusion that the same IPv6 link is extended between these ARs, therefore avoiding the need for any explicit mobility signaling between the mobile node and the NetLMM domain as long as the mobile node remains in that NetLMM domain. In other words, the mobile node preserves its IP address as long as its mobility is confined within the NetLMM domain.

In FIG. 1, a mobile node that moves between one Access Point controlled by an Access Router and another Access Point controlled by the same Access Router (denoted by “Intra-Link Mobility” in FIG. 1) or a mobile node that moves between one Access Point controlled by an Access Router and another Access Point controlled by another Access Router but associated with the same Local Mobility Anchor as the first Access Router (denoted by “Local Mobility” in FIG. 1) remains in one NetLMM domain. However, a Mobile Node that moves between one Access Point controlled by an Access Router associated with one Local Mobility Anchor to another Access Point controlled by an Access Router associated with another Local Mobility Anchor (denoted by “Global Mobility” in FIG. 1) changes from one NetLMM domain to another NetLMM domain.

### SUMMARY

One aspect of the present invention provides a network comprising an NetLMM domain having at least one Host Identity Protocol proxy coupled to one or more Access Points and acting, in use, as an Access Router.

According to the invention, the NetLMM Mobility Access Gateways/Access Routers of the network of FIG. 1 are provided with HIP (Host Identity Protocol) functionality, ie are embodied as HIP proxies. All the typical benefits of HIP are available for making the NetLMM domain more flexible.

The invention provides the following additional benefits compared to the existing solution:
1. The Access Routers/Mobility Access Gateways can themselves be mobile, in the sense that they may be moved around, together with their respective Access Points, with respect to the underlying infrastructure without this being visible to the NetLMM functionality. An example could be a bus having an Access Point and an Access Router, with the passengers' laptops being Mobile Nodes. The entire bus route has network coverage provided by different parties (for example, internet operators/private citizen etc). The Access Router will constantly connect to one of the available access networks, thus providing the Mobile Nodes access to the network to which the Access Router is at that time connected. The Mobile Nodes will not detect mobility, and will keep their IP address, regardless of how many times the access network changes and who provides the access network.
2. The Access Routers can reside in IPv4 networks, and can even be behind NAT (Network Address Translation) boxes.
3. A secure channel can be provided between the Access Routers and the LMA to facilitate deployment of mobile Access Routers in insecure networks.

Each domain may comprise a respective Local Mobility Anchor coupled to the or each HIP proxy in the domain. In such a case, the network architecture of a HIP Proxy based solution can be a traditional NetLMM like network architecture, where a Local Mobility Anchor (LMA) acts both as a central hub and as the termination of HIP traffic towards the Internet, if needed. The LMA may itself be provided with HIP functionality.

Alternatively, the LMA of a NetLMM domain may be provided with HIP functionality instead of the Access Router(s) of the domain. This provides for mobile NetLMM domains.

Alternatively, two or more of the HIP proxies in a domain may be arranged in a distributed manner, for example as described in co-pending PCT application PCT/EP 2007/055930 filed concurrently herewith, Marks & Clerk Reference P54284WO. The network architecture can be fully distributed, with the necessary gateways to the outside world. The combination of the two inventions allows mobile NetLMM Access Routers to be connected with each other without the need for extra infrastructure.

One or more further HIP proxies may be arranged in a hierarchical manner from one of the HIP proxies arranged in the distributed manner.

The domain may comprise a routing table comprising one or more Bloom filters.

At least one HIP proxy may be a mobile proxy.

A second aspect of the present invention provides a method comprising the steps of assigning one or more Host Identity Protocol (HIP) proxies as respective Access Routers of an NetLMM domain.

The method may additionally or alternatively comprise assigning a Host Identity Protocol (HIP) proxy as a Local Mobility Anchor of the domain.

The method may further comprise the steps of:

a) creating a Host Identity Protocol (HIP) association between an HIP proxy and the NetLMM domain;

b) registering the HIP proxy with the domain as a new proxy service provider;

c) determining whether or not to accept the registration; and

d) if the registration is accepted, using the HIP proxy as an Access Router of the domain.

Step (a) may comprise creating the HIP association between the HIP proxy and the Local Mobility Anchor of the domain. Alternatively, it may comprise creating the HIP association between the HIP proxy and an existing HIP proxy of the domain.

The method may comprise the further step of configuring the HIP proxy with the identity of the NetLMM domain before the step of creating the HIP association between the HIP proxy and the NetLMM domain.

The method may comprise the further step of, if the registration is accepted, sending a registration reply to the HIP proxy.

The method may comprise arranging the HIP proxies in the NetLMM domain in a distributed manner.

The method may comprise the further step of, if the registration is accepted, sending details of the registration to at least one other Access Router in the domain.

The method may comprise the step of assigning a Host Identity Protocol (HIP) proxy as a Local Mobility Anchor of a NetLMM domain.

At least one HIP proxy may be a mobile HIP proxy.

Further aspects of the invention provide an Access Router for a NetLMM domain or a Local Mobility Anchor for a NetLMM domain configured with a Host Identity Protocol proxy.

The Access Router may be adapted to perform, in use, the steps of:

a) creating a Host Identity Protocol (HIP) association with an NetLMM domain;

b) registering with the domain as a new proxy service provider; and

c) if the registration is accepted, acting as an Access Router of the domain.

The Access Router may be adapted to create the HIP association between the HIP proxy and a Local Mobility Anchor of the NetLMM domain.

The Access Router may be adapted to create the HIP association between the HIP proxy and an existing HIP proxy of the NetLMM domain.

The Access Router may be adapted to carry out the further step of configuring the HIP proxy with the identity of the NetLMM domain before creating the HIP association between the HIP proxy and the NetLMM domain.

The Access Router may be adapted to receive a registration reply indicating that the registration has been accepted.

The Access Router or Local Mobility Anchor may be configured with a mobile HIP proxy.

Further aspects of the invention provide a network comprising an Access Router or a Local Mobility Anchor of the preceding aspects.

### BRIEF DESCRIPTION OF THE DRAWINGS

Preferred embodiments of the present invention will now be described with reference to the accompanying drawings, in which:

FIG. 1 is a block schematic diagram of a network architecture proposed by the IETF NetLMM working group;

FIG. 2 is a block schematic diagram of a network architecture of the present invention;

FIG. 3 is a block schematic diagram of another network architecture of the present invention;

FIG. 4 is a block schematic diagram of another network architecture of the present invention;

FIG. 5 is a block schematic diagram of another network architecture of the present invention;

FIG. 6 is a block flow diagram of a method of the invention; and

FIG. 7 is a block schematic diagram of another network architecture of the present invention.

### DETAILED DESCRIPTION

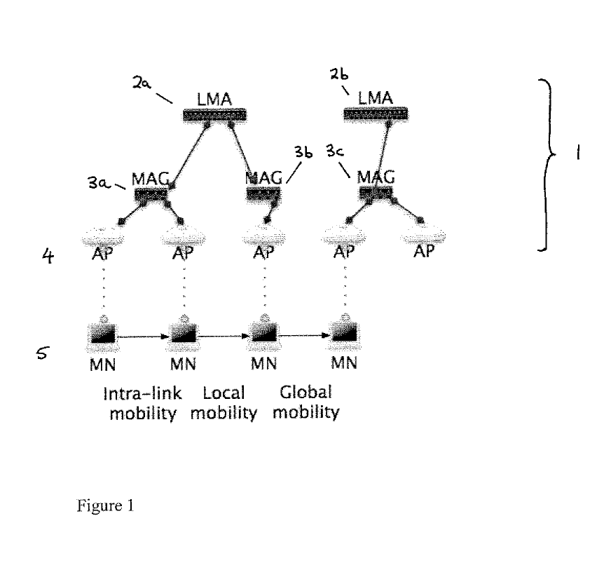

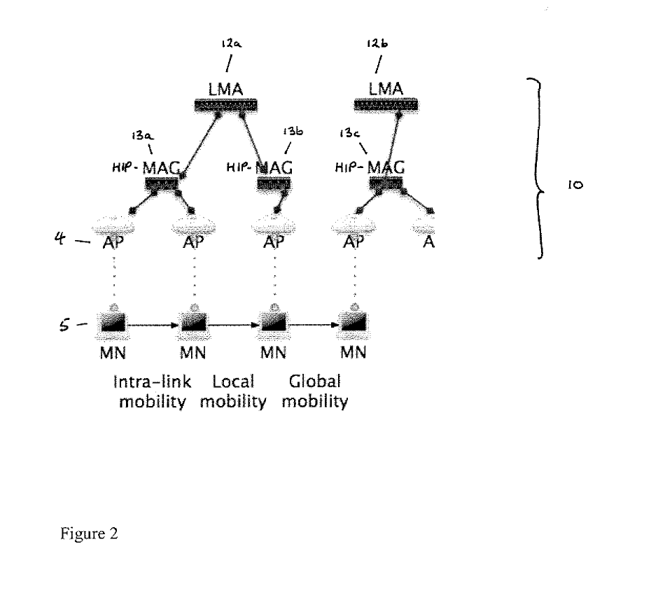

FIG. 2 is a block schematic diagram of a network 10 that allows wireless communication with a mobile device 5. The architecture of the network 10 is similar to the architecture of the NetLMM network of FIG. 1, except that each Access Router/Mobile Access Gateway 3a,3b,3c is embodied as an HIP (Host Identity Protocol) proxy to provide it with HIP functionality.

As is known, the Host Identity Protocol separates the end-point identifier role and locator role of an IP (Internet Protocol) address. It defines a new global Internet name space, that decouples the end-point identifier role and locator role. With HIP, the transport layer operates on Host Identities rather than using IP addresses as endpoint names, while the network layer uses IP addresses as pure locators.

With HIP, an identifier is the public key of a public-private key pair. The HIP Host Identity (HI), being a public key, can be quite long and is therefore not practical in all situations. In HIP, the HI is represented with a 128-bit long Host Identity Tag (HIT) that is generated from the HI by hashing it. Thus, the HIT identifies a HI. Since the HIT is 128 bits long, it can be used for IPv6 applications directly as it is exactly the same length as IPv6 addresses.

Another representation of the Host Identities is the Local Scope Identifier (LSI), which is a 32-bit representation for the Host Identity. The purpose of the LSI is to facilitate using Host Identities in existing protocols and Application Programming Interfaces (APIs). For example, since the LSI is the same length as an IPv4 address, it can be used for IPv4 applications directly.

When HIP is used, the upper layers, including the applications, no longer see the IP address. Instead, they see the HIT (or LSI) as the “address” of the destination host. The location information is hidden at a new layer, to be described below. The IP addresses no longer identify the nodes; they are only used for routing the packets in the network.

Further details of the HIP protocol can be found in, for example, R. Moskowitz and P. Nikander, “Host Identity Protocol Architecture”, Internet-Draft, work in progress, August 2005 or R. Moskowitz, P. Nikander, P. Jokela, and T. Henderson, “Host Identity Protocol”, Internet-Draft, work in progress, October 2005.

In the embodiment of FIG. 2 the Access Routers 13a-13c are again arranged in NetLMM domains, with each domain including a respective Local Mobility Anchor 12a,12b. The first NetLMM domain shown in FIG. 2 comprises two Access Routers 13a,13b and Access Router 13c belongs to a second domain (not shown in full in FIG. 2), but the invention is not limited to the specific arrangement of Access Routers and Access Ports shown in FIG. 2.

The network architecture of the present invention can provide all the features provided by the IETF architecture shown in FIG. 1. In addition, it can provide improved support for mobility within the NetLMM infrastructure, and so can easily support mobile Access Routers as well as stationary Access Routers. The IETF architecture shown in FIG. 1 is however unable to support mobile Access Routers. The present invention may be applied, for example, in the context of deploying wireless networks in cities where the Access Routers could for example be located in buses, thus benefiting from the mobility and route optimization provided by HIP.

One problem with mobile Access Routers is security. If an Access Router is mobile, the available security level of the access networks is likely to fluctuate as the Access Router moves. The present invention can provide high security even with a mobile Access Router, since a HIP mobile proxy may establishes a secure channel between an Access Router and the associated LMA, thereby preventing hijacking of the connection or tracking of mobile nodes, and facilitating deployment of mobile Access Routers in insecure networks (although the mobile nodes access network remains unprotected).

Furthermore, all the typical benefits of HIP are available for making the NetLMM domain more flexible, including easy deployment over both IPv4 (IP version 4) and IPv6 (IP version 6), and route optimisation between Access Routers. Moreover, the Access Routers can even be behind NAT (Network Address Translation) boxes, provided that the NAT box is provided between an Access Router and the LMA at which the Access Router is registered.

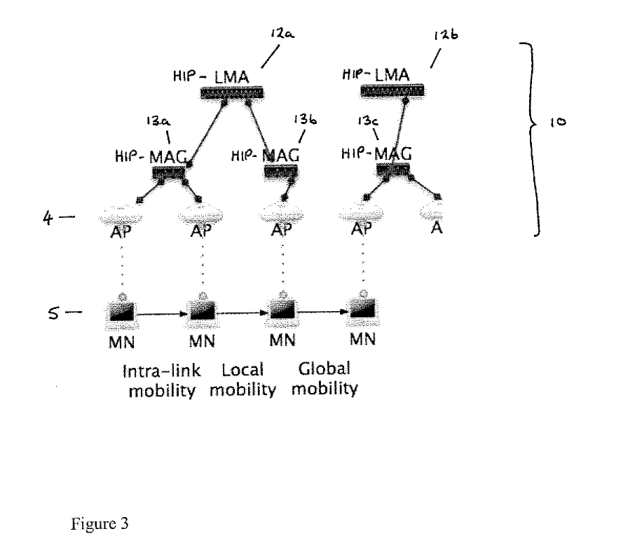

In a further embodiment of the invention, the Local Mobility Anchors are also embodied as HIP proxies to provide them with HIP functionality. This embodiment is shown schematically in FIG. 3. Apart from providing the Local Mobility Anchors with HIP functionality, the embodiment of FIG. 3 corresponds to the embodiment of FIG. 2.

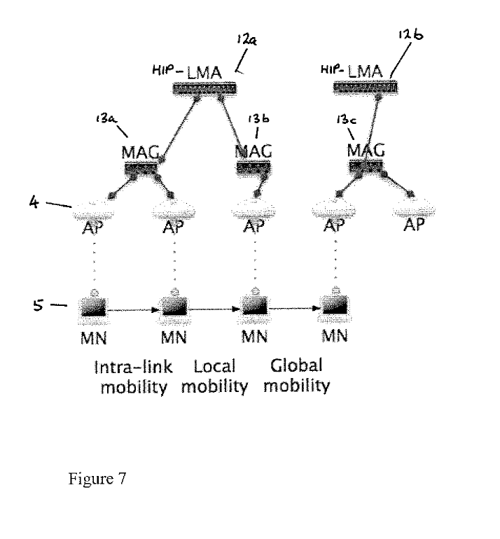

In a further embodiment of the invention, a Local Mobility Anchor of an NetLMM domain is embodied as an HIP proxy to provide it with HIP functionality, instead of the Access Routers. This embodiment is shown schematically in FIG. 7, in which the Local Mobility Anchors 12a,12b of both NetLMM domains shown in the figure are embodied as HIP proxies. In FIG. 7, any Mobile Node behind one Local Mobility Anchor 12a is able to connect with any Mobile Node behind the other Local Mobility Anchor 12b. It should however be noted that a legacy host which is not HIP aware would not be able to connect to a mobile Local Mobility Anchor. Where it is desired to connect to a non-HIP aware legacy host, the top-most entity in a network hierarchy must be static. (In FIG. 7 the Local Mobility Anchors of both NetLMM domains shown in the figure are embodied as HIP proxies, but it would in principle be possible for some, but not all, domains to have their Local Mobility Anchors embodied as HIP proxies—in general, when a NetLMM domain is mobile, there needs to be at least one HIP capable host in the domain.)

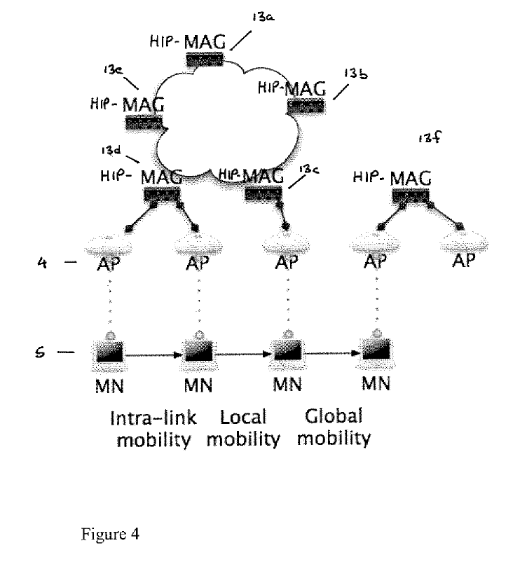

The network architectures of FIGS. 2, 3 and 7 are hierarchical architectures, in which each domain is provided with a respective Local Mobility Anchor acting both as a central hub and as the termination of HIP traffic towards the Internet, if needed. The invention is not limited to a hierarchical architecture, however, and may be applied to an architecture in which the Access Routers of a domain have a distributed architecture, with no Local Mobility Anchor. Such an embodiment is illustrated schematically in FIG. 4, in which Access Routers 13a-13e belong to one NetLMM domain and Access Routers 13f belongs to another NetLMM domain (not shown in full in FIG. 4). The distributed Access Router architecture of FIG. 4 is described in detail in co-pending application PCT/EP 2007/055930, Marks & Clerk Reference P54284WO to which attention is directed but, in summary, each router 13a-13e in a NetLMM domain is provided with routing information, such as Bloom filter, which lists which mobile nodes are currently behind each of the other Access Routers of that NetLMM domain. In this embodiment the present invention enables the establishment of a secure channel between one Access Router and another Access Router, thereby again preventing hijacking of the connection or tracking of mobile nodes, and facilitating deployment of mobile Access Routers in insecure networks.

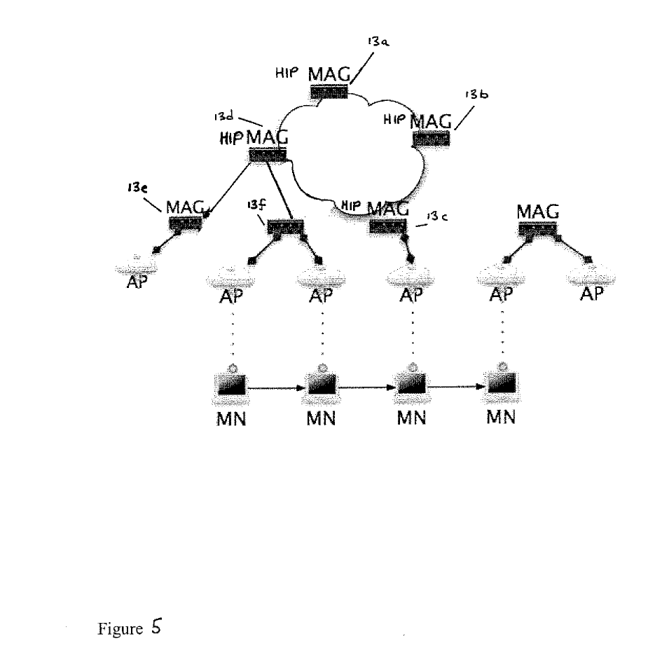

The invention may also be applied to a partly-distributed architecture, for example as shown in FIG. 5. In the partly-distributed architecture of FIG. 5, the Access Routers 13a-13d have a distributed architecture, as described above. Access Router 13d, however, represents a hierarchy of Access routers, here represented by two Access Routers 13e,13f. The routing information provided by Access Routers 13d to the other Access Routers 13a-13c of the domain contains information about Mobile Nodes located behind Access Router 13e, behind Access Router 13f and behind Access Router 13d (in the case that any Access Points are connected directly to Access Router 13d). When an incoming packet destined for a Mobile Node behind any of the Access Routers 13d,13e or 13f is received at, for example, Access Router 13a, Access Router 13a will consult its routing information, determine that the packet should be sent to Access Router 13d, and send the packet to Access Router 13d.

Access Router 13d maintains the individual routing information (for example Bloom filters) for the Access Routers 13e,13f that are underneath it as well as its own local routing information (Bloom filter). Upon arrival of a packet at Access Router 13d, Access Router 13d consults the routing information to determine whether the Mobile Node to which the packet is destined is behind Access Router 13d itself, is behind Access Router 13e, or is behind Access Router 13f, and routes the packet accordingly.

In the embodiments of FIGS. 2, 3, 4 and 5, no modification is required to the Mobile Nodes or to the Access Points.

Various steps in maintenance of a NetLMM domain of the network architecture of the invention will now be described. By “domain maintenance” is meant dynamic adding or removing of HIP proxies. At the highest level, this does not differ much from the procedures needed in other NetLMM architectures for addition or removal of Access Routers/Mobility Access Gateways. However, on the assumption that all the infrastructure nodes (Access Routers/Mobility Access Gateways, and Local Mobility Anchors if any) implement HIP, it is possible to describe a more detailed solution than do the current IETF documents.

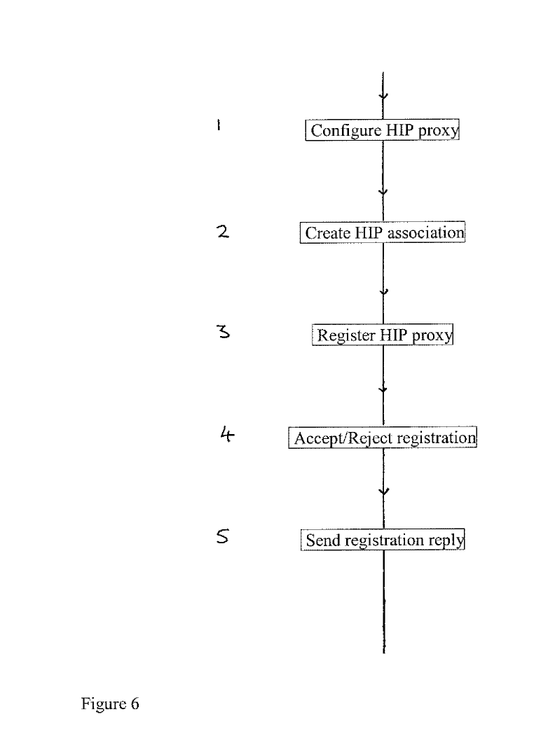

To add a new HIP proxy to a NetLMM domain to serve as an Access Router/Mobility Access Gateway the following procedure, shown schematically in FIG. 6, is envisaged:
1. The new HIP proxy is either configured (step 1) with the identity of the domain (such as the Host Identity Tag (HIT) of the LMA) or discovers the domain through some other means, such as the HIP service discovery protocol [P. Jokela, et al, “HIP Service Discovery”, Internet draft draft-jokela-hip-service-discovery-00, work in progress, June 2006];
2. The new HIP proxy creates a HIP association with the domain (step 2);
   a. If the network architecture is a traditional one, the HIP association is created with the LMA;
   b. If the network architecture is a distributed one, the HIP association is created with any of the existing HIP proxies (AR/MAGs);
3. The new HIP proxy registers itself with the domain as a new proxy service provider (step 3), using the HIP registration protocol [J. Laganier, et al, “Host Identity Protocol (HIP) Registration Extension”, Internet draft draft-ietf-hip-registration-02, work in progress, June 2006];
4. The domain (LMA or MAG) either accepts or rejects the registration (step 4), depending on the configured security policy. In the case of distributed architecture, the policy may require a quorum to be formed among the already participating HIP proxies, or some other distributed decision making procedure. If the registration is rejected, the procedure terminates in a failure.
   a. If the domain is implemented in a distributed fashion, either the registration needs to be distributed to the other participating proxies, or
   b. The proxies participating to the decision making can jointly sign a certificate authorising the new proxy to serve in the domain.
5. In the registration reply sent upon acceptance of a registration request (step 5), the HIP proxy receives the needed configuration parameters, such as the routing prefix used in the NetLMM domain. In the case of a distributed architecture, the proxy also receives information about the network architecture (e.g. using Bloom Filters [http://en.wikipedia.org/wiki/Bloom_filter]);
6. Once registered, the proxy is ready to serve mobile nodes.

If the above mentioned HIP registration procedure is used to join the domain, the proxy will be automatically dropped from the domain at the expiry of the registration and/or the issued certificate, unless it is renewed.

A HIP proxy may prematurely stop serving in the domain simply by removing all mobile nodes that are behind it. No other action is needed, as the information will automatically be removed at other proxies as soon as the registration expires.

Alternatively, there may be a separate, signed discontinuation messages, sent to the LMA or distributed to all participating AR/MAGs.

When a new mobile node arrives at some HIP proxy, the Mobile Node needs to be assigned an IPv6 address. This address is assigned from the routing prefix assigned to the domain, as defined in J. Laganier, S. Narayanan, F. Templin, “Network-based Localized Mobility Management Interface between Mobile Node and Access Router”, Internet Draft draft-ietf-NetLMM-mn-ar-if-01, work in progress, June 2006.

There are no fundamental differences in node mobility within a domain between the HIP proxy based architectures of the invention and other NetLMM architectures. Similarly, there are no fundamental differences concerning disappearing mobile nodes between HIP proxy based architectures of the invention and other NetLMM architectures.

There are no fundamental differences in establishment of a connection between the HIP proxy based architectures of the invention and other NetLMM architectures. However, a HIP proxy based architecture allows route optimizations in cases where both mobile nodes are within the same NetLMM domain.

In the case of a distributed HIP proxy based architecture, as shown in FIG. 4, all AR/MAGs in a NetLMM domain have the necessary information (utilizing Bloom filters) to route packets to the peer AR/MAGs inside the NetLMM domain.

In the case of a traditional hierarchical architecture as in FIG. 2 or 3, the AR/MAG of the sending client will notice by the destination address when the peer is within the same NetLMM domain. Thereby, it is possible to optimize routing in a hierarchical architecture by establishing a direct connection between the AR/MAGs concerned. This could, for example, be implemented by integrating a rendezvous server as proposed by J. Laganier and L. Eggert, “Host Identity Protocol (HIP) Rendezvous Extension”, Internet Draft draft-ietf-hip-rvs-05, work in progress, July 2006 into the LMA.

It should be noted that the invention is not limited to the specific arrangements and numbers of Access Points and Access Routers shown in FIGS. 2 to 5 and 7, and that the arrangements and numbers of Access Points and Access Routers may be varied from those shown in FIGS. 2 to 5 and 7.

1. A network comprising an NetLMM domain having at least one Host Identity Protocol (HIP) proxy coupled to one or more Access Points and acting, in use, as an Access Router.

2. A network as claimed in claim 1 wherein the domain comprises a Local Mobility Anchor coupled to the or each HIP proxy in the domain.

3. A network as claimed in claim 2 wherein the Local Mobility Anchor is an HIP Local Mobility Anchor.

4. A network as claimed in claim 1 wherein the HIP proxies in a domain are arranged in a distributed manner.

5. A network as claimed in claim 1 wherein two or more HIP proxies of the HIP proxies in a domain are arranged in a distributed manner, and one or more further HIP proxies of the HIP proxies in a domain are arranged in a hierarchical manner from one of the HIP proxies arranged in the distributed manner.

6. A network as claimed in claim 4 or 5 wherein the domain comprises a routing table comprising one or more Bloom filters.

7. A network comprising an NetLMM domain having at least one Host Identity Protocol proxy acting, in use, as a Local Mobility Anchor for the domain.

8. A network as claimed in any preceding claim wherein at least one HIP proxy is a mobile proxy.

9. A method comprising the steps of assigning one or more Host Identity Protocol (HIP) proxies as respective Access Routers of an NetLMM domain.

10. A method as claimed in claim 9 and further comprising assigning a further Host Identity Protocol (HIP) proxy as a Local Mobility Anchor of the domain.

11. A method as claimed in claim 9 or 10 and comprising the steps of:
a) creating a Host Identity Protocol (HIP) association between an HIP proxy and the NetLMM domain;
b) registering the HIP proxy with the domain as a new proxy service provider;
c) determining whether or not to accept the registration; and
d) if the registration is accepted, using the HIP proxy as an Access Router of the domain.

12. A method as claimed in claim 11 when dependent from claim 10 wherein step (a) comprises creating the HIP association between the HIP proxy and the Local Mobility Anchor of the domain.

13. A method as claimed in claim 11 wherein step (a) comprises creating the HIP association between the HIP proxy and an existing HIP proxy of the domain.

14. A method as claimed in claim 11, 12 or 13, and comprising the further step of configuring the HIP proxy with the identity of the NetLMM domain before the step of creating the HIP association between the HIP proxy and the NetLMM domain.

15. A method as claimed in one of claims 11 to 14 and comprising the further step of, if the registration is accepted, sending a registration reply to the HIP proxy.

16. A method as claimed in claim 11 when dependent from claim 9 and comprising arranging the HIP proxies in the NetLMM domain in a distributed manner.

17. A method as claimed in one of claims 11 to 16 and comprising the further step of, if the registration is accepted, sending details of the registration to at least one other Access Router in the domain.

18. A method comprising the step of assigning a Host Identity Protocol (HIP) proxy as a Local Mobility Anchor of an NetLMM domain.

19. A method as claimed in any of claims 11 to 18 wherein at least one HIP proxy is a mobile HIP proxy.

20. An Access Router for an NetLMM domain configured with a Host Identity Protocol (HIP) proxy.

21. An Access Router as claimed in claim 20 and adapted to perform, in use, the steps of:
a) creating a Host Identity Protocol (HIP) association with an NetLMM domain;
b) registering with the domain as a new proxy service provider; and
c) if the registration is accepted, acting as an Access Router of the domain.

22. An Access Router as claimed in claim 21 and adapted to create the HIP association between the HIP proxy and a Local Mobility Anchor of the NetLMM domain.

23. An Access Router as claimed in claim 21 and adapted to create the HIP association between the HIP proxy and an existing HIP proxy of the NetLMM domain.

24. An Access Router as claimed in claim 21 and adapted to carry out the further step of configuring the HIP proxy with the identity of the NetLMM domain before creating the HIP association between the HIP proxy and the NetLMM domain.

25. An Access Router as claimed in claim 21 and adapted to receive a registration reply indicating that the registration has been accepted.

26. An Access Router as claimed in any of claims 20 to 25 and configured with a mobile HIP proxy.

27. A Local Mobility Anchor for an NetLMM domain configured with an Host Identity Protocol (HIP) proxy.

28. A Local Mobility Anchor as claimed in claim 27 and configured with a mobile HIP proxy.

29. A network comprising an Access Router as defined in any of claims 20 to 26.

30. A network comprising a Local Mobility Anchor as defined in claim 27 or 28.
